(19) United States
(12) Patent Application Publication
(10) Pub. No.: US 2015/0047208 A1
(43) Pub. Date: Feb. 19, 2015

(54) DOUBLE FULCRUM TOOL

(71) Applicant: Amitai Holenberg, Moshav Zippori (IL)

(72) Inventor: Amitai Holenberg, Moshav Zippori (IL)

(21) Appl. No.: 13/969,746

(22) Filed: Aug. 19, 2013

(51) Int. Cl. B28D 1/22; B26B 17/02

(52) U.S. Cl. CPC B28D 1/228; B28D 1/225; B26B 17/02
USPC 30/188; 81/342

(57) ABSTRACT

A tool including a first jaw extending from a distal portion of an elongate member, a second jaw pivotally attached to a first fulcrum at the distal portion of the elongate member, wherein a first force amplifier including an elongate lever extends from the second jaw towards a proximal end of the elongate member, and a second force amplifier including an elongate handle pivotally attached to a second fulcrum at a proximal portion of the elongate member, the elongate handle including a distal grasping portion and a pushing member arranged to push against a proximal portion of the elongate lever thereby to move the second jaw towards the first jaw.

### FIELD OF THE INVENTION

The present invention relates generally to cutting or grasping tools, such as but not limited to, for tiles or mosaic tiles, and in particular to such a cutting or grasping tool with enhanced mechanical advantage.

### BACKGROUND OF THE INVENTION

Brittle tiles, especially mosaic tiles, are typically cut to the desired size and shape with cutting tools, such as nipping tools, also referred to as nippers or nipper cutters. The tiles must be cut into sizes and shapes for fitting properly in a particular position in a design. Similarly, pliers or other grasping tools are used to handle the tiles.

A drawback to known prior art tools is the lack of sufficient mechanical advantage to cut the brittle, yet hard tiles.

### SUMMARY OF THE INVENTION

The present invention seeks to provide an improved cutting or grasping tool, such as but not limited to, for tiles (the tool can be used for cutting or grasping other items and not just tiles), with enhanced mechanical advantage, as described more in detail hereinbelow. Cutting encompasses cutting, breaking, slicing, shearing and others. Grasping encompasses grasping, holding, squeezing, and others. The tool has a double fulcrum, which can increase the mechanical advantage of the tool's levers.

In prior art cutting or grasping tools, increasing the cutting or grasping force is accomplished by moving the user's hand further away from the cutting or grasping jaws. This has the disadvantage of decreasing control and accuracy on the cutting or grasping action. Another disadvantage is the cutting or grasping force is applied between the thumb and pinkie or ring finger of the hand (due to the fact that the place for maximum force is furthest away from the jaws). In contrast, in the present invention, increasing the cutting or grasping force is accomplished by moving the user's hand closer to the cutting or grasping jaws. This has the synergistic advantage of increasing control and accuracy on the cutting or grasping action. The cutting or grasping force is applied between the thumb and forefinger of the hand, which is more forceful (due to the fact that the place for maximum force is closest to the jaws).

There is thus provided in accordance with an embodiment of the present invention a tool including a first jaw extending from a distal portion of an elongate member, a second jaw pivotally attached to a first fulcrum at the distal portion of the elongate member, wherein a first force amplifier including an elongate lever extends from the second jaw towards a proximal end of the elongate member, and a second force amplifier including an elongate handle pivotally attached to a second fulcrum at a proximal portion of the elongate member, the elongate handle including a distal grasping portion and a pushing member arranged to push against a proximal portion of the elongate lever thereby to move the second jaw towards the first jaw. The first and second jaws may include cutting jaws or grasping jaws.

In accordance with an embodiment of the present invention the elongate handle includes a plurality of mounting zones for the pushing member.

In accordance with an embodiment of the present invention the proximal portion of the elongate member is not collinear with the distal portion of the elongate member. Alternatively, the proximal portion of the elongate member may be collinear with the distal portion of the elongate member.

In accordance with an embodiment of the present invention the grasping portion is bent in a direction away from the elongate member.

In accordance with an embodiment of the present invention a safety keeper is arranged to lock movement of the elongate handle with respect to the elongate member.

### BRIEF DESCRIPTION OF THE DRAWINGS

The present invention will be understood and appreciated more fully from the following detailed description, taken in conjunction with the drawings in which:

FIGS. 1 and 2 are simplified pictorial and front-view illustrations, respectively, of a tool, constructed and operative in accordance with a non-limiting embodiment of the present invention; and

FIGS. 3 and 4 are simplified pictorial and front-view illustrations, respectively, of a tool, constructed and operative in accordance with another non-limiting embodiment of the present invention.

### DETAILED DESCRIPTION OF EMBODIMENTS

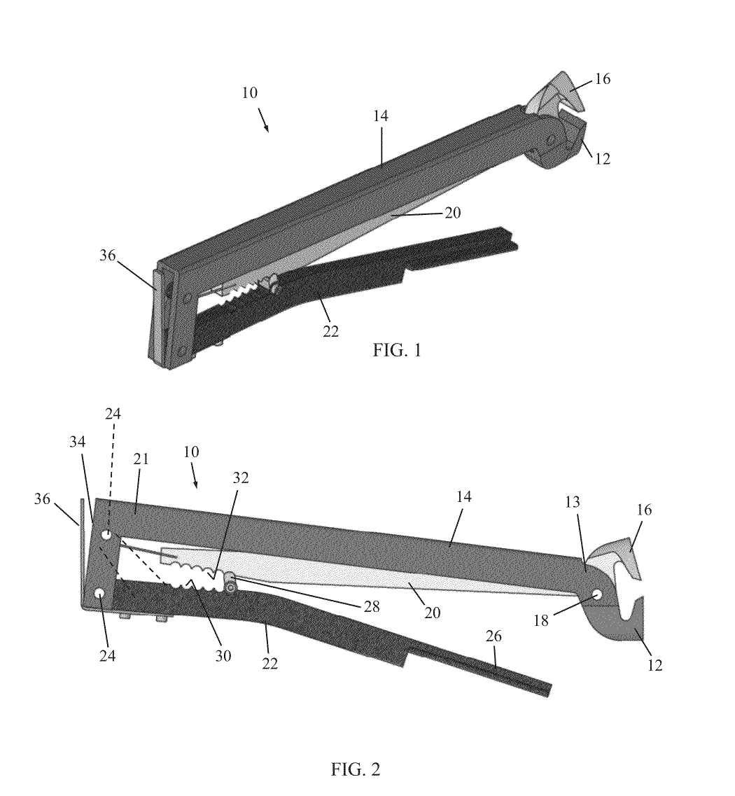

Reference is now made to FIGS. 1 and 2, which illustrate a tool 10, constructed and operative in accordance with a non-limiting embodiment of the present invention.

Tool 10 includes a first jaw 12 extending from a distal portion 13 of an elongate member 14 (distal means closer to the jaws). A second jaw 16 is pivotally attached to a first fulcrum 18 at the distal portion 13 of elongate member 14. A first force amplifier including an elongate lever 20 extends from the second jaw 16 towards a proximal end 21 of elongate member 14.

A second force amplifier including an elongate handle 22 is pivotally attached to a second fulcrum 24 at a proximal portion of elongate member 14. Elongate handle 22 includes a distal grasping portion 26 and a pushing member 28 arranged to push against a proximal portion of elongate lever 20. The pushing member 28 may be attached to elongate handle 22 or alternatively to elongate lever 20. Alternatively pushing member 28 is not a separate piece but rather a portion of elongate handle 22 or elongate lever 20. Elongate handle 22 includes a plurality of mounting zones 30 for pushing member 28, such as but not limited to, indentations formed in elongate handle 22. Similarly, elongate lever 20 includes a plurality of zones 32 for pushing member 28 to push against, such as but not limited to, indentations formed in elongate lever 20.

In accordance with a non-limiting embodiment of the present invention, the proximal portion of the elongate member 14, where second fulcrum 24 is located, is not collinear with the distal portion of elongate member 14; rather it is an extension 34 which may be perpendicular to the rest of elongate member 14. Alternatively, as indicated by broken lines in FIG. 2, the proximal portion of the elongate member 14, where second fulcrum 24 is located, may be collinear with the distal portion of elongate member 14.

In accordance with a non-limiting embodiment of the present invention the grasping portion 26 of elongate handle 22 is bent in a direction away from elongate member 14.

Optionally, a safety keeper 36 is arranged to lock or limit movement of elongate handle 22 with respect to elongate member 14.

In operation, the user grasps grasping portion 26 of elongate handle 22 and squeezes the handle 22 towards elongate member 14. This action pushes pushing member 28 against elongate lever 20 and moves second jaw 16 towards first jaw 12. The first and second jaws may be cutting jaws or grasping jaws. A biasing device, such as a spring, can be added to return either of the jaws to its original position.

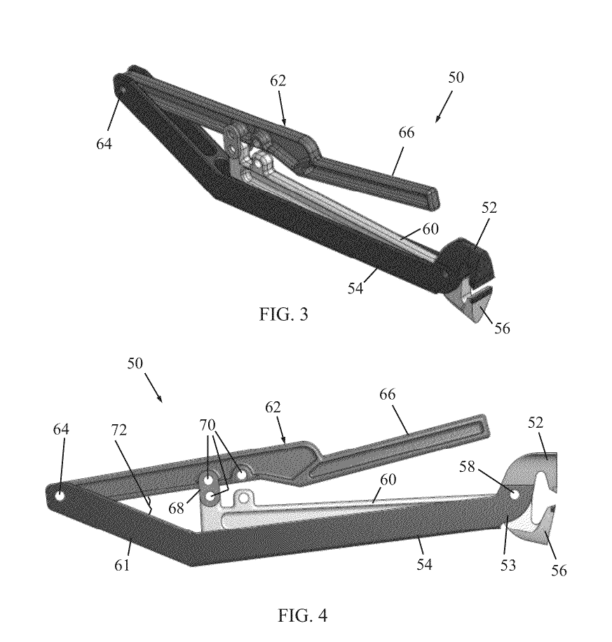

Reference is now made to FIGS. 3 and 4, which illustrate a tool 50, constructed and operative in accordance with another non-limiting embodiment of the present invention.

Tool 50 includes a first jaw 52 extending from a distal portion 53 of an elongate member 54. A second jaw 56 is pivotally attached to a first fulcrum 58 at the distal portion 53 of elongate member 54. A first force amplifier including an elongate lever 60 extends from the second jaw 56 towards a proximal end 61 of elongate member 54.

A second force amplifier including an elongate handle 62 is pivotally attached to a second fulcrum 64 at a proximal portion of elongate member 54. Elongate handle 62 includes a distal grasping portion 66 and a pushing member 68 arranged to push against a proximal portion of elongate lever 60. The pushing member 68 may be attached to elongate handle 62 and to elongate lever 60 by a pinned connection or other suitable connection. Elongate handle 62 includes a plurality of mounting zones 70 for pushing member 68, such as but not limited to, mounting holes formed in elongate handle 62 and elongate lever 60. A biasing member 72 (shown in FIG. 4), such as a coil or leaf spring, urges elongate handle 62 away from elongate member 54.

The scope of the present invention includes both combinations and subcombinations of the features described hereinabove as well as modifications and variations thereof which would occur to a person of skill in the art upon reading the foregoing description and which are not in the prior art.

What is claimed is:

1. A tool comprising:
a first jaw extending from a distal portion of an elongate member;
a second jaw pivotally attached to a first fulcrum at the distal portion of said elongate member, wherein a first force amplifier comprising an elongate lever extends from said second jaw towards a proximal end of said elongate member; and
a second force amplifier comprising an elongate handle pivotally attached to a second fulcrum at a proximal portion of said elongate member, said elongate handle comprising a distal grasping portion and a pushing member arranged to push against a proximal portion of said elongate lever thereby to move said second jaw towards said first jaw.

2. The tool according to claim 1, wherein more distal application of a grasping force applied to said distal grasping portion increases a force applied by motion of said second jaw towards said first jaw.

3. The tool according to claim 1, wherein said elongate handle comprises a plurality of mounting zones for said pushing member.

4. The tool according to claim 1, wherein a biasing member urges said elongate handle away from said elongate member.

5. The tool according to claim 1, wherein said first and second jaws comprise cutting jaws.

6. The tool according to claim 1, wherein said first and second jaws comprise grasping jaws.

7. The tool according to claim 1, further comprising a safety keeper arranged to lock or limit movement of said elongate handle with respect to said elongate member.
